(19) United States
(12) Patent Application Publication
(10) Pub. No.: US 2025/0354908 A1
(43) Pub. Date: Nov. 20, 2025

(54) DEVICE FOR TESTING THE LOW-TEMPERATURE CAVITATION OF INDUCER AND TEST METHOD

(71) Applicant: ZHEJIANG UNIVERSITY OF WATER RESOURCES AND ELECTRIC POWER, Hangzhou City (CN)

(72) Inventors: Xiaomei GUO, Hangzhou City (CN); Sunwuji WANG, Hangzhou City (CN); Zuchao ZHU, Hangzhou City (CN); Fengqin LI, Hangzhou City (CN); Haowen LI, Hangzhou City (CN); Yuhao CHEN, Hangzhou City (CN)

(21) Appl. No.: 18/899,017

(22) Filed: Sep. 27, 2024

(30) Foreign Application Priority Data
May 17, 2024 (CN) 202410612124.9

(51) Int. Cl. G01N 3/56

(52) U.S. Cl. CPC G01N 3/567; G01N 2203/0228; G01N 2203/0641

(57) ABSTRACT

A device for testing a low-temperature cavitation of an inducer and a test method are provided. The device includes an inducer cavitation test assembly, a first liquid storage tank configured for storing a liquid medium therein and having an outlet connected with an inlet of the temperature control assembly, and a temperature control assembly having an outlet connected with an inlet of the inducer cavitation test assembly. An outlet of the inducer cavitation test assembly is connected with an inlet of the first liquid storage tank. The temperature control assembly is configured for controlling the temperature of the liquid medium from the first liquid storage tank into the inducer cavitation test assembly. The inlet of the inducer cavitation test assembly is connected with a gas storage tank for conveying gas. The inducer cavitation test assembly is configured for testing an inducer.

### CROSS-REFERENCE TO RELATED APPLICATION

This patent application claims the benefit and priority of Chinese Patent Application No. 202410612124.9 filed with the China National Intellectual Property Administration on May 17, 2024, the disclosure of which is incorporated by reference herein in its entirety as part of the present application.

### TECHNICAL FIELD

The present disclosure relates to the technical field of inducer tests, in particular to a device for testing the low-temperature cavitation of an inducer and a test method.

### BACKGROUND

Generally, the three methods such as a numerical simulation method, a theoretical modeling method and a test method may be used to study the low-temperature flow problem of the inducer. However, cavitation involves turbulence, phase change, two-phase flow and other complex phenomena, and the cavitation process of the low-temperature medium is coupled with the heat transfer problem. Therefore, low-temperature cavitation is extremely complicated. At present, it is difficult to achieve the expected research objects by theoretical and numerical simulation, and the test method is still one of the most important research methods. Low-temperature cavitation test technology is a difficult technology at present.

The existing inducer test table only considers the working environment of the inducer under conventional working conditions, without considering the condition of gas evolution at the inlet of the inducer.

### SUMMARY

The present disclosure aims to provide a device for testing the low-temperature cavitation of an inducer and a test method, which are capable of simulating a test under a working condition of inlet gas gradual evolution of the inducer.

In order to achieve the purpose, the present disclosure provides the following scheme.

The present disclosure provides a device for testing a low-temperature cavitation of an inducer. The device includes an inducer cavitation test assembly, a first liquid storage tank and a temperature control assembly. The first liquid storage tank is configured for storing a liquid medium therein. An outlet of the first liquid storage tank is connected with an inlet of the temperature control assembly. An outlet of the temperature control assembly is connected with an inlet of the inducer cavitation test assembly. An outlet of the inducer cavitation test assembly is configured for connecting with an inlet of the first liquid storage tank. The temperature control assembly is configured for controlling the temperature of the liquid medium from the first liquid storage tank into the inducer cavitation test assembly. The inlet of the inducer cavitation test assembly is also connected with a gas storage tank. The gas storage tank is configured for conveying gas. The inducer cavitation test assembly is configured for testing an inducer.

In some embodiments, the device for testing the low-temperature cavitation of the inducer also includes a conventional inducer test assembly and a second liquid storage tank. The conventional inducer test assembly is provided therein with a conventional inducer test station for testing, the outlet of the first liquid storage tank is connected with an inlet of the conventional inducer test assembly through a pipeline, an outlet of the conventional inducer test assembly is connected with an inlet of the second liquid storage tank, and an outlet of the second liquid storage tank is connected with the inlet of the first liquid storage tank.

In some embodiments, the device for testing the low-temperature cavitation of the inducer also includes a heater. The heater is connected with the temperature control assembly, and the heater is configured for heating the temperature control assembly.

In some embodiments, the device for testing the low-temperature cavitation of the inducer also includes a pressure control box. The pressure control box is connected with the outlet of the first liquid storage tank. The pressure control box is connected with the heater. The pressure control box is also configured for connecting with the inlet of the second liquid storage tank.

In some embodiments, the device for testing the low-temperature cavitation of the inducer also includes a vacuum pump. The vacuum pump is located on a pipeline between the outlet of the first liquid storage tank and the inlet of the inducer cavitation test assembly. An optical probe is provided on a pipeline between the outlet of the temperature control assembly and the inlet of the inducer cavitation test assembly. The optical probe is configured for detecting the content of gas entering into the inducer cavitation test assembly.

In some embodiments, a thermometer and a first pressure gauge are also provided on the pipeline between the outlet of the temperature control assembly and the inlet of the inducer cavitation test assembly. A supercooling tank and a flowmeter are provided on a pipeline between the outlet of the inducer cavitation test assembly and the inlet of the second liquid storage tank. The supercooling tank is connected with a make-up pump through a pipeline.

In some embodiments, the inlet of the inducer cavitation test assembly is connected with the outlet of the inducer cavitation test assembly through a pipeline provided with a second pressure gauge.

In some embodiments, the inducer cavitation test assembly includes an inducer cavitation visual test station, a fill light and a camera. The fill light and the camera are located outside the inducer cavitation visual test station. The inducer cavitation visual test station is configured for placing an inducer therein. The inducer inside the inducer cavitation visual test station is provided with a plurality of equally-spaced pressure pulsation sensors and a plurality of equally-spaced temperature sensors along the helical direction of blades of the inducer.

The present disclosure also provides a test method of a device for testing a low-temperature cavitation of an inducer, including the following working conditions.

Under a first working condition, when the inducer is tested under a gas evolution working condition, starting the inducer inside the inducer cavitation test assembly to work, opening a valve at the outlet of the first liquid storage tank, introducing the liquid medium from the first liquid storage tank into the pipeline, first controlling the temperature of the liquid medium in the temperature control assembly in accordance with the temperature of test requirements, then filling the pipeline at the inlet of the inducer cavitation test assembly with gas through a delivery pump, simulating the gas evolution working condition, detecting the gas content by the optical probe, then introducing the liquid medium with evolved gas into the inducer cavitation test assembly, visually observing the working condition of the inducer inside the inducer cavitation test assembly, introducing the liquid medium with evolved gas into the supercooling tank through the inducer cavitation test assembly, so that the evolved gas is liquefied into liquid at low temperature and the liquid returns back to the first liquid storage tank to complete the liquid cycle.

Under a second working condition, when the inducer is tested under a conventional working condition, opening a valve outside the first liquid storage tank, introducing the liquid medium from the first liquid storage tank into the pipeline and into the conventional inducer test station of the conventional inducer test assembly, carrying out an inducer test under the conventional working condition, and returning the liquid medium back to the first liquid storage tank to complete the cycle.

Compared with the prior art, the present disclosure has the following technical effects.

The present disclosure can simulate a test under a working condition of inlet gas gradual evolution of the inducer. The temperature control assembly is used to ensure that the liquid in the first liquid storage tank does not gasify. The delivery pump is arranged at the inlet of the inducer cavitation test assembly to make up gas so as to simulate the inlet gas gradual evolution of the inducer, and the content of the makeup gas at the inlet of the inducer is monitored by using the optical probe, so as to achieve the purposes of simulating a working condition of inlet gas gradual evolution of the inducer and monitoring the gas content.

### BRIEF DESCRIPTION OF THE DRAWINGS

To more clearly illustrate the present embodiment of the present disclosure or the technical scheme in the prior art, the following briefly introduces the attached figures to be used in the present embodiment. Apparently, the attached figures in the following description show merely some embodiments of the present disclosure, and those skilled in the art may still derive other drawings from these attached figures without creative efforts.

FIG. 1 is a schematic diagram of a device for testing the low-temperature cavitation of an inducer in the present disclosure.

FIG. 2 is a front view of an inducer in the present disclosure.

FIG. 3 is a top view of an inducer in the present disclosure.

FIG. 4 is a schematic diagram of an inducer on an inducer cavitation visual test station in the present disclosure.

FIG. 5 is a schematic diagram of design positions of multiple pressure pulsation sensors and multiple temperature sensors on an inducer in the present disclosure.

Reference signs: 1, first liquid storage tank; 2, second liquid storage tank; 3, inducer cavitation test assembly; 4, conventional inducer test assembly; 5, vacuum pump; 6, heater; 7, temperature control assembly; 8, delivery pump; 9, optical probe; 10, supercooling tank; 11, make-up pump; 12, pressure control box; 13, flowmeter; 14, silencer; 15, first pressure gauge; 16, second pressure gauge; 17, gas storage tank; 18, thermometer; 19, inducer cavitation visual test station; 20, inducer; 21, camera; and 22, fill light.

### DETAILED DESCRIPTION OF THE EMBODIMENTS

The following clearly and completely describes the technical scheme in the embodiments of the present disclosure with reference to the embodiments of the present disclosure. Apparently, the described embodiments are merely a part rather than all of the embodiments of the present disclosure. Based on the present embodiment in the present disclosure, all other embodiments obtained by the ordinary technical staff in the art under the premise of without contributing creative labor belong to the scope protected by the present disclosure.

The present disclosure aims to provide a device for testing the low-temperature cavitation of an inducer and a test method capable of simulating a test under a working condition of inlet gas gradual evolution of the inducer.

To make the foregoing objective, features and advantages of the present disclosure clearer and more comprehensible, the present disclosure is further described in detail below with reference to the attached figures and specific embodiments.

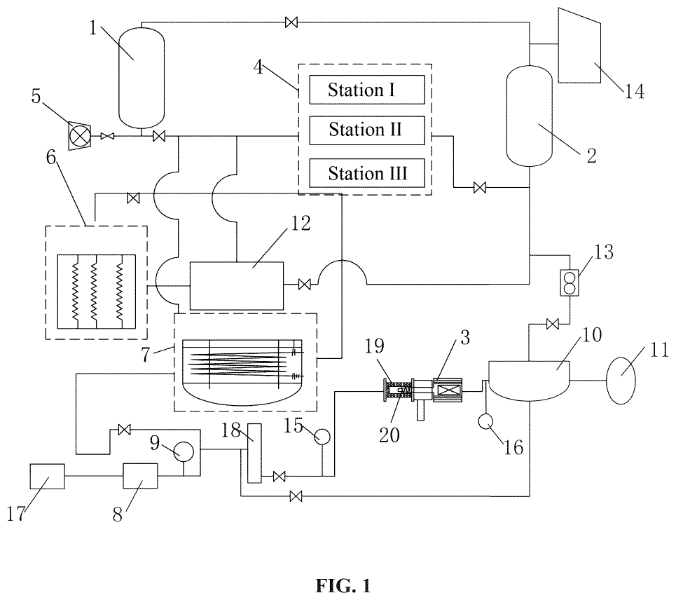

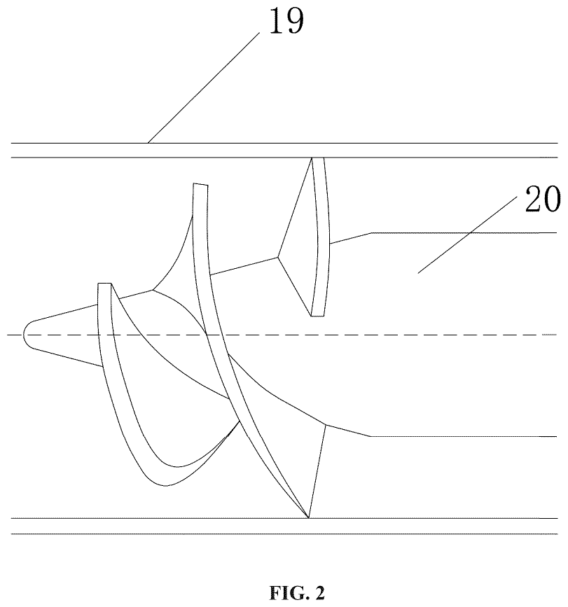

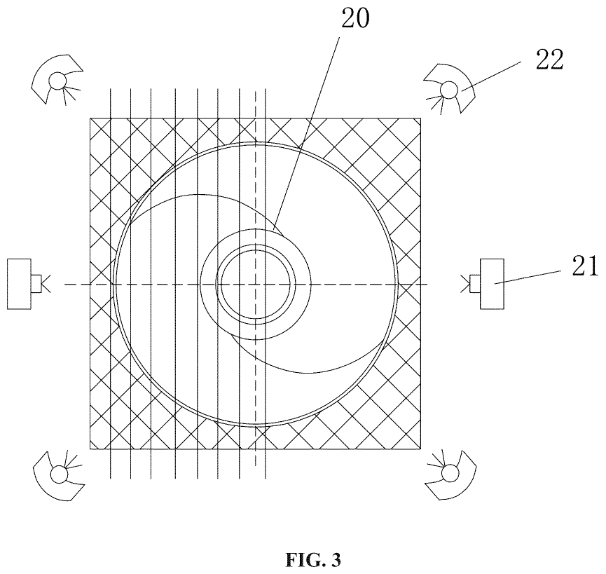

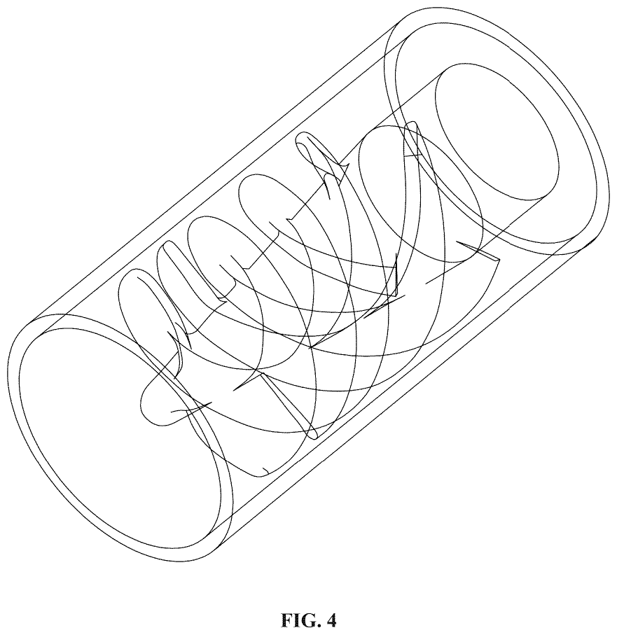

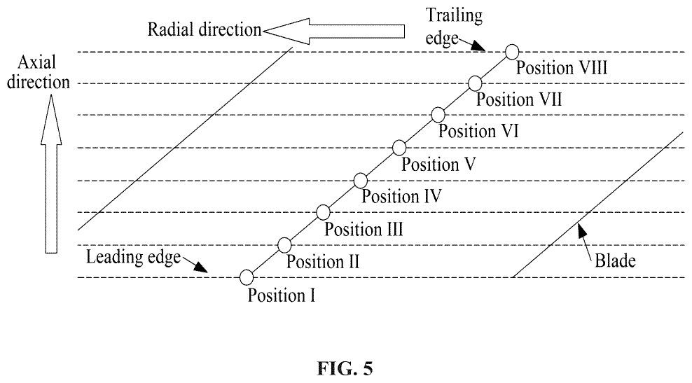

As shown in FIGS. 1 to 5, the embodiment provides a device for testing the low-temperature cavitation of an inducer, which includes an inducer cavitation test assembly 3, a first liquid storage tank 1 and a temperature control assembly 7. The first liquid storage tank 1 is configured for storing a liquid medium therein. An outlet of the first liquid storage tank 1 is connected with an inlet of the temperature control assembly 7. An outlet of the temperature control assembly 7 is connected with an inlet of the inducer cavitation test assembly 3. An outlet of the inducer cavitation test assembly 3 is configured for connecting with an inlet of the first liquid storage tank 1. The temperature control assembly 7 is configured for controlling the temperature of the liquid medium from the first liquid storage tank 1 into the inducer cavitation test assembly 3. The inlet of the inducer cavitation test assembly 3 is also connected with a gas storage tank 17. The gas storage tank 17 is configured for conveying gas. The inducer cavitation test assembly 3 is configured for testing an inducer 20.

Specifically, in the embodiment, a conventional inducer test assembly 4 is provided therein with a plurality of conventional inducer test stations for testing. The outlet of the first liquid storage tank 1 is connected with an inlet of the conventional inducer test assembly 4 through a pipeline. An outlet of the conventional inducer test assembly 4 is connected with an inlet of the second liquid storage tank 2. A valve is provided on a pipeline between the outlet of the conventional inducer test assembly 4 and the inlet of the second liquid storage tank 2. An outlet of the second liquid storage tank 2 is connected with the inlet of the first liquid storage tank 1. A valve is provided on a pipeline between the outlet of the second liquid storage tank 2 and the inlet of the first liquid storage tank 1.

In the embodiment, a heater 6 is a water-bath heater.

In the embodiment, a pressure control box 12 is connected with the outlet of the first liquid storage tank 1, is connected with the heater 6, and is also connected with a pipeline between the inlet of the second liquid storage tank 2 and the outlet of the inducer cavitation test assembly 3.

In the embodiment, the vacuum pump 5 is located on a pipeline between the outlet of the first liquid storage tank 1 and the inlet of the inducer cavitation test assembly 3. The vacuum pump 5 is configured for regulating the pressure of the inlet of the inducer cavitation test assembly 3 to realize cavitation control. An optical probe 9 is provided on a pipeline between the outlet of the temperature control assembly 7 and the inlet of the inducer cavitation test assembly 3. The optical probe 9 is configured for detecting the content of gas entering into the inducer cavitation test assembly 3. The optical probe 9 may detect the content of gas transferred by the delivery pump 8.

In the embodiment, a thermometer 18 and a first pressure gauge 15 are also provided on the pipeline between the outlet of the temperature control assembly 7 and the inlet of the inducer cavitation test assembly 3. The thermometer 18 is configured for measuring the temperature at the inlet of the inducer cavitation test assembly 3, and the first pressure gauge 15 is configured for measuring the pressure at the inlet of the inducer cavitation test assembly 3. A supercooling tank 12 and a flowmeter 13 are provided on a pipeline between the outlet of the inducer cavitation test assembly 3 and the inlet of the second liquid storage tank 2. The flowmeter 13 is configured for detecting the flow of liquid passing through the inducer cavitation test assembly 3. The supercooling tank 10 is connected with a make-up pump 11 through a pipeline. The make-up pump 11 is configured for connecting with an external liquid medium source, and is configured for making up liquid medium consumed and lost in the test process.

In the embodiment, the inlet of the inducer cavitation test assembly 3 (i.e., an inlet of an inducer cavitation visual test station 19) is connected with the outlet of the inducer cavitation test assembly 3 (i.e., an outlet of the inducer cavitation visual test station 19) through a pipeline provided with a second pressure gauge 16. The second pressure gauge 16 is configured for measuring the pressure at the outlet of the inducer cavitation test assembly 3.

The measured temperature at the inlet of the inducer cavitation test assembly 3, the amount of gas evolution at the inlet of the inducer cavitation test assembly 3, the gas flow through the inducer cavitation test assembly 3, the pressure at the inlet of the inducer cavitation test assembly 3 and the pressure at the outlet of the inducer cavitation test assembly 3 are used as numerical calculation boundary conditions to be substituted into numerical simulation software. The numerical calculation under a working condition of inlet gas gradual evolution of the inducer 20 is carried out.

In the embodiment, the inducer cavitation test assembly 3 includes an inducer cavitation visual test station 19, a fill light 22 and a camera 21. The fill light 22 and the camera 21 are located outside the inducer cavitation visual test station 19. The inducer cavitation visual test station 19 is made of organic glass. The camera 21 is preferably a PCO.1200hs high-resolution and high-speed camera of American Cooke Company, and is configured for carrying out visual shooting such as inducer 20 cavitation flow. Two synchronous high-speed cameras are symmetrically arranged on both sides of the inducer cavitation visual test station 19. Four fill lights 22 are located at the left upper, left lower, right upper and right lower positions of the inducer cavitation visual test station 19 to ensure light sufficiency for clear shooting. Laser sheet light sources irradiated above the inducer 20 ensure that shot pictures are clearer. The inducer cavitation test assembly 3 may observe the distribution condition of the flow field inside the inducer 20 under different working conditions of the liquid medium. The structures, forms, quantity, development evolution process and the like of bubbles during cavitation inside the inducer 20 are observed. Visual tests of a single inducer 20 and a high-speed inducer centrifugal pump may be carried out. The inducer cavitation visual test station 19 is an organic glass pipeline with a rectangular cross section. Blades of the inducer are wrapped so as to observe the production and development processes of bubbles during cavitation. The inducer 20 on the inducer cavitation visual test station is provided with a plurality of equally-spaced pressure pulsation sensors and a plurality of equally-spaced temperature sensors along the helical direction of the blades of the inducer 20. Pressure pulsation is detected by the pressure pulsation sensors to further explore the influence on the operation of the inducer 20 under a working condition of inlet gas gradual evolution of the inducer 20. The temperature is detected by the temperature sensors.

In the embodiment, a silencer 14 is also provided, and is configured for reducing the operating noise of a complete set of test equipment.

The present disclosure solves the problem that the actual gas evolution working condition is difficult to test. The liquid medium flows out of the first liquid storage tank 1. The temperature of the liquid medium is controlled to prevent the liquid medium from being gasified when the liquid medium flows through the temperature control assembly 7 so as to ensure that evolved gas completely comes from the delivery pump 8. When the liquid medium flows through the inlet of the inducer cavitation test assembly 3, gas is made up through the delivery pump 8 to simulate a working condition of inlet gas gradual evolution of the inducer 20. At the same time, the test may be carried out by introducing different amounts of gas at the inlet of the inducer cavitation test assembly 3. Capture shooting is carried out on the cavitation by the camera 21.

The present disclosure realizes a centrifugal pump low-temperature performance test of the high-speed inducer, and is mainly used for studying the influence of gas gradual evolution process on inducer low-temperature cavitation flow and the gas gradual evolution process on low-temperature cavitation inhibition measures.

The following tests may be carried out. The first test is a non-cavitation performance test. A low-temperature liquid nitrogen test is carried out on the inducer by the conventional inducer test assembly 4 to obtain the data of a performance test of the inducer under the working conditions with different temperatures, flows and different amounts of inlet gas evolution. The performance test mainly measures the lift and efficiency of the inducer under non-cavitation states. The second test is a low-temperature cavitation performance test. The data of the low-temperature cavitation performance test are carried out. The pressure information at the parts such as the inlet and the outlet of the inducer and a volute outlet are collected, and the information, such as flow, torque and power, are measured. According to the cavitation performance test, under the circumstance of different amounts of inlet gas evolution, the inlet pressure is gradually reduced, and the parameters, such as lift and efficiency, of the inducer are recorded respectively. The influence of internal flow of the inducer on the performance of the pump is judged by the lift changes of the inducer and the pump. The low-temperature cavitation performance test under different geometrical parameters of the inducer is carried out to establish a relation between the geometrical parameters of the inducer and low-temperature cavitation, so that the most effective low-temperature cavitation inhibition measures are proposed.

Compared with the traditional low-temperature cavitation test table, the present disclosure realizes the low-temperature cavitation simulation test of inlet flow gas at the inlet of the inducer, thus making up for the vacancy of the traditional low-temperature cavitation test table under the working condition of inlet flow gas. The obtained test data may also correct a formula in the numerical simulation software, so that the numerical simulation result is more accurate. In addition, the present disclosure may carry out other tests under conditions, such as different flow rates, different inlet pressure conditions, different inducer rotating speeds and different blade tip clearances in addition to the test of measuring the inlet gas gradual evolution condition, and may carry out the tests under different working conditions.

### Embodiment II

A test method of the device for testing the low-temperature cavitation of an inducer includes the following working conditions.

Under the first working condition, when the inducer 20 is tested under a gas evolution working condition, the liquid medium is stored in the first liquid storage tank 1 and the second liquid storage tank 2. When the inducer 20 inside the inducer cavitation test assembly 3 starts to work, a valve at the outlet of the first liquid storage tank 1 is opened, the liquid medium flows into the pipeline from the first liquid storage tank 1. First the temperature of the liquid medium is controlled in the temperature control assembly 7 to be in accordance with the temperature of test requirements, and then gas is filled into the pipeline at the inlet of the inducer cavitation test assembly 3 through a delivery pump 8. The gas evolution working condition is simulated. The gas content is detected by the optical probe 9, and then the liquid medium with evolved gas enters into the inducer cavitation test assembly 3, the working condition of the inducer 20 inside the inducer cavitation test assembly 3 is visually observed. The first pressure gauge 15 and the second pressure gauge 16 in front of and at the back of the inducer cavitation test assembly 3 are configured for measuring front and rear pressures, respectively. The flowmeter 13 may measure the flow flowing through the inducer cavitation test assembly 3. The thermometer 18 is configured for measuring the temperature of the inflowing liquid. The vacuum pump 5 may change the pressure at the inlet of the inducer cavitation test assembly 3. The pressure control box 12 controls the specific pressure value. When the pressure of the system or equipment exceeds a preset range, the pressure sensors inside the pressure control box 12 detects signals and transmit the signals into a control circuit. The control circuit may automatically judge whether the pressure is out of the set range, and gives instructions for an output actuator. The output actuator adjusts the pressure by adjusting the opening of the valve to keep the pressure within the set range. When the pressure is stable, the actuator stops adjusting. The silencer 14 is configured for reducing the operating noise of a complete set of test equipment. The liquid medium with evolved gas flows through the inducer cavitation test assembly 3 and then enters into the supercooling tank 10 to liquefy the evolved gas into liquid at low temperature, and the liquid returns back to the first liquid storage tank 1 and the second liquid storage tank 2 to complete the liquid cycle.

Under the second working condition, when the inducer is tested under a conventional working condition, i.e., under the condition that the gas is not evolved, a valve outside the first liquid storage tank 1 is opened, the liquid medium flows into the pipeline from the first liquid storage tank 1 to enter into the conventional inducer test station of the conventional inducer test assembly 4 so as to carry out an inducer test under the conventional working condition, and then the liquid medium returns back to the first liquid storage tank 1 to complete the cycle.

Specific examples are used for illustration of the principles and implementation methods of the present disclosure. The description of the above-mentioned embodiments is used to help illustrate the method and the core principles of the present disclosure; and meanwhile, those skilled in the art can make various modifications in terms of specific embodiments and scope of application in accordance with the teachings of the present disclosure. In summary, the contents of this specification should not be understood as the limitation of the present disclosure.

What is claimed is:

1. A device for testing a low-temperature cavitation of an inducer, comprising:
an inducer cavitation test assembly having an inlet connected with a gas storage tank configured for conveying gas and an outlet,
a first liquid storage tank storing a liquid medium therein and having an inlet and an outlet; and
a temperature control assembly having an inlet connected to the outlet of the first liquid storage tank and an outlet also connected with the inlet of the inducer cavitation test assembly,
the outlet of the inducer cavitation test assembly is connectable with the inlet of the first liquid storage tank,
the temperature control assembly controlling a temperature of the liquid medium from the first liquid storage tank into the inducer cavitation test assembly, wherein the inducer cavitation test assembly is configured for testing an inducer.

2. The device for testing the low-temperature cavitation of the inducer according to claim 1, further comprising
a conventional inducer test assembly provided with a conventional inducer test station for testing and having an inlet connected with the outlet of the first liquid storage tank through a pipeline, and an outlet; and
a second liquid storage tank having an inlet connected to the outlet of the conventional inducer test assembly and an outlet connected with the inlet of the first liquid storage tank.

3. The device for testing the low-temperature cavitation of the inducer according to claim 2, further comprising a heater connected with the temperature control assembly, and being configured for heating the temperature control assembly.

4. The device for testing the low-temperature cavitation of the inducer according to claim 3, further comprising a pressure control box connected with the outlet of the first liquid storage tank, the pressure control box being further connected with the heater and is configured for connecting with the inlet of the second liquid storage tank.

5. The device for testing the low-temperature cavitation of the inducer according to claim 1, further comprising:
a vacuum pump located on a pipeline between the outlet of the first liquid storage tank and the inlet of the inducer cavitation test assembly, and
an optical probe provided on a pipeline between the outlet of the temperature control assembly and the inlet of the inducer cavitation test assembly, and is configured to detect content of gas entering into the inducer cavitation test assembly.

6. The device for testing the low-temperature cavitation of the inducer according to claim 2, further comprising:
a thermometer and a first pressure gauge provided on the pipeline between the outlet of the temperature control assembly and the inlet of the inducer cavitation test assembly,
a supercooling tank and a flowmeter provided on a pipeline between the outlet of the inducer cavitation test assembly and the inlet of the second liquid storage tank, the supercooling tank being connected with a make-up pump through a pipeline.

7. The device for testing the low-temperature cavitation of the inducer according to claim 1, wherein the inlet of the inducer cavitation test assembly is connected with the outlet of the inducer cavitation test assembly through a pipeline provided with a second pressure gauge.

8. The device for testing the low-temperature cavitation of the inducer according to claim 1, wherein the inducer cavitation test assembly comprises:
an inducer cavitation visual test station configured for receiving an inducer therein, the inducer inside the inducer cavitation visual test station being provided with a plurality of equally-spaced pressure pulsation sensors and a plurality of equally-spaced temperature sensors along a helical direction of blades of the inducer
a fill light; and
a camera, wherein the fill light and the camera are located outside the inducer cavitation visual test station.

9. A test method employing the device for testing the low-temperature cavitation of the inducer according to claim 1, comprising the following working conditions:
under a first working condition, when the inducer is tested under a gas evolution working condition:
starting the inducer inside the inducer cavitation test assembly to work,
opening a valve at the outlet of the first liquid storage tank,
introducing the liquid medium from the first liquid storage tank into the pipeline,
first controlling the temperature of the liquid medium in the temperature control assembly in accordance with the temperature of test requirements,
then filling the pipeline at the inlet of the inducer cavitation test assembly with gas through a delivery pump,
simulating the gas evolution working condition, detecting the gas content by the optical probe,
then introducing the liquid medium with evolved gas into the inducer cavitation test assembly,
visually observing the working condition of the inducer inside the inducer cavitation test assembly,
introducing the liquid medium with evolved gas into the supercooling tank through the inducer cavitation test assembly, so that the evolved gas is liquefied into liquid at low temperature and the liquid returns back to the first liquid storage tank to complete the liquid cycle;
under a second working condition, when the inducer is tested under a conventional working condition:
opening a valve outside the first liquid storage tank,
introducing the liquid medium from the first liquid storage tank into the pipeline and into the conventional inducer test station of the conventional inducer test assembly,
carrying out an inducer test under the conventional working condition, and
returning the liquid medium back to the first liquid storage tank to complete the cycle.

10. The test method according to claim 9, further comprising:
a conventional inducer test assembly provided therein with a conventional inducer test station for testing, an inlet connected with the outlet of the first liquid storage tank through a pipeline, and an outlet; and
a second liquid storage tank having an inlet connected to the outlet of the conventional inducer test assembly and an outlet connected with the inlet of the first liquid storage tank.

11. The test method according to claim 10, further comprising a heater connected with the temperature control assembly, the heater being configured for heating the temperature control assembly.

12. The test method according to claim 11, further comprising a pressure control box connected with the outlet of the first liquid storage tank, the pressure control box being further connected with the heater, and is configured for connecting with the inlet of the second liquid storage tank.

13. The test method according to claim 9, further comprising:
a vacuum pump located on a pipeline between the outlet of the first liquid storage tank and the inlet of the inducer cavitation test assembly, and
an optical probe provided on a pipeline between the outlet of the temperature control assembly and the inlet of the inducer cavitation test assembly, and is configured to detect content of gas entering into the inducer cavitation test assembly.

14. The test method according to claim 10, further comprising:
a thermometer and a first pressure gauge provided on the pipeline between the outlet of the temperature control assembly and the inlet of the inducer cavitation test assembly,
a supercooling tank and a flowmeter provided on a pipeline between the outlet of the inducer cavitation test assembly and the inlet of the second liquid storage tank, the supercooling tank being connected with a make-up pump through a pipeline.

15. The test method according to claim 9, wherein the inlet of the inducer cavitation test assembly is connected with the outlet of the inducer cavitation test assembly through a pipeline provided with a second pressure gauge.

16. The test method according to claim 9, wherein the inducer cavitation test assembly comprises:
an inducer cavitation visual test station configured for placing an inducer therein, the inducer inside the inducer cavitation visual test station is provided with a plurality of equally-spaced pressure pulsation sensors and a plurality of equally-spaced temperature sensors along a helical direction of blades of the inducer;
a fill light; and
a camera, wherein the fill light and the camera are located outside the inducer cavitation visual test station.
